(19) United States
(12) Patent Application Publication
(10) Pub. No.: US 2005/0160088 A1
(43) Pub. Date: Jul. 21, 2005

(54) System and method for metadata-based distribution of content

(76) Inventors: Todd Scallan, Los Gatos, CA (US); William G. Cuan, Sunnyvale, CA (US); Meili Zhong, San Jose, CA (US); Patrick Fu, Cupertino, CA (US)

Correspondence Address: GLENN PATENT GROUP, 3475 EDISON WAY, SUITE L, MENLO PARK, CA, 94025, US

(21) Appl. No.: 11/031,309

(22) Filed: Jan. 6, 2005

Related U.S. Application Data
(63) Continuation-in-part of application No. 11/000,573, filed on Nov. 30, 2004.
Application No. 11/000,573 is a continuation-in-part of application No. 09/860,893, filed on May 17, 2001, now abandoned.

(51) Int. Cl. G06F 17/30

(52) U.S. Cl. 707/3

(57) ABSTRACT

In a system for metadata-based distribution of content, metadata queries are used to specify rules for content distribution jobs, allowing flexible, intelligent deployment, expiration and syndication of code and content across an enterprise or content network. A configurable payload adapter receives the metadata query, parses and translates the metadata into a form specific to the particular implementation, and then queries a metadata repository to identify a list of digital assets that satisfy the specified criterion specified by the metadata. The assets are retrieved from a content repository and distributed, syndicated and/or expired according to the distribution rules. Intelligent delivery of digital assets enables syndication of content based on offers and subscriptions.

### CROSS-REFERENCE TO RELATED APPLICATION

This Application is a Continuation-in-part of U.S. patent application Ser. No. 11/000,573, filed Nov. 30, 2004, which is a Continuation-in-part of U.S. patent application Ser. No. 09/860,893, filed May 17, 2001.

### BACKGROUND OF THE INVENTION

1. Technical Field

The invention relates generally to multi-computer transfer of data. More particularly the invention relates to methods for configuring deployments of content for distribution across an enterprise.

2. Description of Related Art

One of the major challenges posed by the developing web-based application environment is the problem of deploying code and content to multiple network touch points across an enterprise. Conventional distribution processes are often based on FTP (file transfer protocol), a mechanism for exchanging files between servers over the Internet. However, FTP-based processes are often unsecured, expensive to maintain, and difficult to scale or they are difficult to integrate with other applications. Some proprietary technologies such as CRS (CONTENT REPLICATION SERVER, Microsoft Corporation, Redmond Wash.) offer adequate distribution capacity within their respective environments, but they offer little value in distributed, multi-application and multi-platform environments.

In recognition of such needs, the parent to the present application, U.S. patent application Ser. No. xx/xxx,xxx, titled SYSTEM AND FOR TRANSACTIONALLY DEPLOYING CONTENT ACROSS MULTIPLE MACHINES, filed Nov. 30, 2004, the content of which is hereby incorporated in its entirety as if fully set forth herein, describes a system for transactionally deploying content across multiple machines in a network environment that automates and synchronizes the secure and reliable distribution of code, content and configurations to multiple network locations, thereby allowing controlled provisioning and synchronization of code and content updates to live applications. The system provides for deployment configuration files—XML (Extensible Markup Language)-based files to specify elements and attributes that describe how a deployment is to work. A variety of deployment types were described, for example file list deployments and directory comparison deployments. Additionally, the parent mentioned a metadata-based deployment.

Metadata is information associated with a digital asset. Metadata can describe the asset, the content of the asset, and document its relationship with other assets and the organization, often thought of as the asset's context. Metadata can also document the use and continuing management of the asset. The art provides a number of examples of the use of metadata in computational environments.

D. Reed, P. Heyman, S. Mushero, K. Jones, J. Oberlander, Computer-based communication system and method using metadata defining a control structure, U.S. Pat. No. 6,088,717 (Jul. 11, 2000) and D. Reed, P. Heyman, S. Mushero, K. Jones, J. Oberlander, D. Banay, Computer-based communication system and method using metadata defining a control structure, U.S. Pat. No. 6,345,288 (Feb. 5, 2002) describe an automated communication system wherein data, metadata and methods are transferred between provider and consumer computers to update a communications control structure, resident on both computers, that controls origination of outgoing communications from the provider computer and the processing of incoming communications to the consumer computer. The use of metadata allows automation of many of the actions underlying the communications, such as communication acknowledgements and archiving.

Similar to Reed, et al., supra, B. Hartley, F. Ricotta, J. Wanderwall, T. Locke, T. Perkins, R. Brown, Operational system for operating on client defined rules, U.S. patent application pub. no. 2001/0032207 (Oct. 18, 2001), U.S. Pat. No. 6,532,465 (Mar. 11, 2003), and U.S. patent application pub. no. 2003/0163472 (Aug. 28, 2003) describe a computational system for operating on externally-defined data based on client-defined rules. Rules and metadata allow the computational architecture to be customized for a particular application.

P. Stickler, Method and apparatus for information delivery with archive containing metadata in predetermined language and semantics, U.S. patent application pub. no. 2003/0088573 (May 8, 2003) describes an information delivery system that includes a content repository, which is mapped by metadata held in archive. External queries, formulated using the metadata language, allow retrieval of media items from the repository.

S. Sim, D. Chan, T. Huang, W. Chai, T. Isaacson, J. Flood, G. Mills, M. Orzen, Method and system for managing distributed content and related metadata, U.S. patent application pub. no. 2002/0133491 (Sep. 19, 2002) describes a method and system for creating a file system that separates its directory presentation from its data store. File system objects are distributed across the network in a manner that minimizes the time required to download an object without the necessity of providing large amount of redundant storage. The system uses object metadata and a metafile system architecture to control integrity of distributed objects.

However, none of the examples contemplates the use of metadata as a means of configuring a content deployment across an enterprise. It would be a great advance over current methods of deploying content to specify which content is to be deployed plus additional important parameters concerning the distribution action through the use of metadata queries. It would be a great advantage if distribution rules based on metadata queries were to enable the flexible deployment and expiration of code and content across the enterprise. Moreover, it would be a further advantage to additionally enable expiration and syndication of digital assets based on metadata queries.

### SUMMARY OF THE INVENTION

The invention provides a method whereby distribution jobs are specified using metadata-based rules or queries, allowing flexible deployment, expiration and syndication of code and content across an enterprise or content network. The distribution rules allow for smart deployments of content payloads and deployment actions. Rules are based on both the content itself and metadata, both internal and user-defined. In essence, a metadata repository can be interrogated to determine the manifest of content that meets the criterion specified by the metadata rules. A configurable payload adapter receives the metadata query, parses it and translates the metadata into a form specific to the particular implementation. The payload adapter then queries a metadata repository to identify a list of digital assets that satisfy the criterion specified by the metadata. The assets are retrieved from a content repository and distributed, syndicated and/or expired according to the metadata rules.

An intelligent delivery module enables syndication of content on an offer and subscription basis. A user interface allows offers to be configured using metadata rules. Subscriptions are created by scheduling distribution jobs that correspond to offers. Such distribution jobs typically deliver updates to specific audiences at certain times or at recurring intervals. Business contract rules and/or recipient preferences often dictate the delivery schedule.

### BRIEF DESCRIPTION OF THE DRAWINGS

FIG. 1 provides a top-level block diagram of a system for metadata-based distribution of content according to the invention;

FIG. 2 provides a control flow diagram from the system of FIG. 1 according to the invention;

FIG. 3 provides a detailed block diagram of an architecture for intelligent deployment of content from the system of FIG. 1 according to the invention;

FIG. 4 provides screen shots of user interfaces for configuring offers and subscriptions from the system of FIG. 3 according to the invention;

FIG. 5 provides a stack diagram of a service-oriented architecture from the system of FIG. 3 according to the invention; and

FIG. 6 provides a screen shot of a user interface for scheduling deployments from the system of FIG. 3 according to the invention.

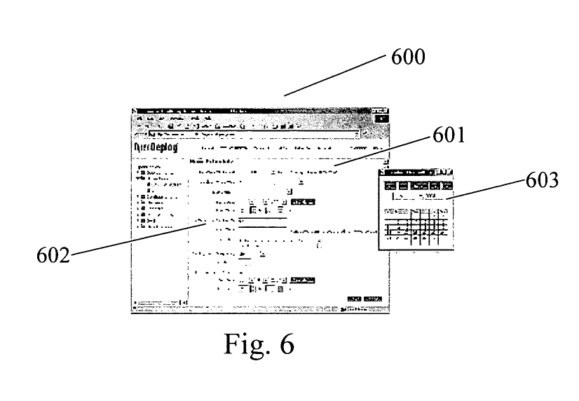

### DETAILED DESCRIPTION

The following detailed description should be read with reference to the drawings. The drawings depict illustrative embodiments that are not intended to limit the scope of the invention.

Conventionally, in content management systems, assets to be retrieved from a repository and deployed are specified in a file list that names each asset individually by one or both of the filename of the asset and the pathname, the pathname indicating where, within the asset repository, the asset is to be found.

Metadata, often referred to as “data about data,” is information associated with a digital asset. Metadata can describe the asset, describe its content, document its relationship with other records and the organization (the asset's context) and describe the encoding of the content. Metadata can also document the use and continuing management of the asset.

Advantageously, metadata-based distribution provides a highly flexible way of specifying which content is to be distributed and in what manner. Distribution rules can be specified using metadata queries to enable the flexible deployment and expiration of code and content across an enterprise. Moreover, metadata-based distribution enables “offer and subscription” syndication of digital assets and provides a strategic foundation for ECD (enterprise content distribution) within content networks.

The invention provides a method whereby distribution jobs are specified using metadata-based rules or queries. In essence, a metadata repository can be interrogated to determine the manifest of content that meets some criterion. For example, embodiments of the invention allow specification of deployments in at least the following ways:

TABLE 1

| Action | Example |
|---|---|
| Deploy assets based | Deploy files with archive = true and importance = |
| on arbitrary metadata | high |
| Deploy assets based on | Deploy reports with publication data after 1 |
| publication date | May 2003 |
| Delete assets based on | Expire web pages with expiration data after 15 |
| expiration data | May 2003 |
| Deliver assets to | Deploy reports tagged with |
| specific audiences | recipientGroup = FundScribers |

The deployment actions listed above are only provided to illustrate the principles of the invention, and are not intended to limit the invention. The types of deployment actions possible in a system are a function of the particular deployment and the metadata structure particular to the implementation.

In order to allow retrieval and deployment of assets from any type of asset repository, the invention employs an adapter-based approach, utilizing payload adapters customized to the particular asset repository. In one embodiment of the invention, the payload adapter allows distribution rules to be formulated using an XML—(Extensible Markup Language) based query language. Another embodiment of the invention allows the query to be formulated as a CDATA (character data string) using a query language, SQL for example, particular to the repository.

The invention includes a scheduler to launch distribution jobs at specific times or regular intervals to support asset publication, expiration and syndication. In addition, content syndication preferably relies on delivery adapters, when necessary, to transmit content via alternate protocols, such as FTP, and e-mail.

The ability to specify metadata-based distribution rules within deployment configurations does not preclude the use of other deployment features. The invention can be implemented in systems alongside conventional pattern or path-based filters.

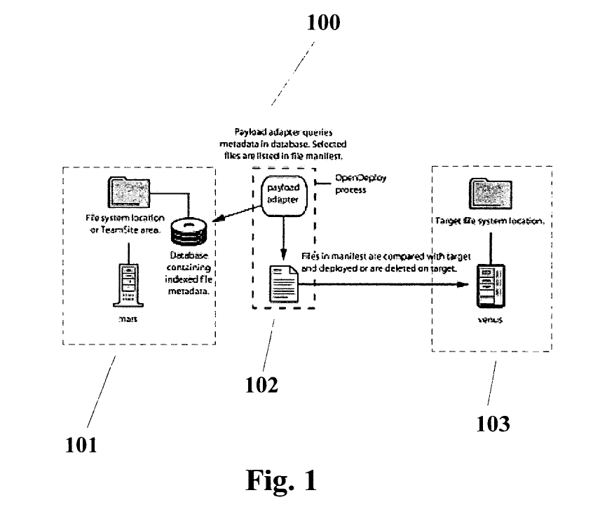

Referring now to FIG. 1, a top-level block diagram of a system for metadata-based distribution 100 of content is shown. A payload adapter on a base server 102 queries a metadata repository on a source 101. The payload adapter prepares a file manifest of assets that satisfy the query. Subsequently, the manifest may be compared with the files on a target 103. Based on the comparison, files are deployed to the target, from a content repository at the source 101, and/or files are expired and deleted at the target. Alternatively, comparison of the manifest with the files on the target is optional. In this embodiment of the invention, the files listed in the manifest may be directly deployed without any comparison. For purposes of illustration, the base server 102 and the source 101 are shown as separate elements. In one embodiment of the invention, the elements 101 and 102 are physically distinct from each other and are in communication with each other by means of a network connection. Suitable means of relaying data between a source and a base server will be readily apparent to one having an ordinary level of skill in the art. Another embodiment is possible wherein the two elements 101 and 102 are provided as distinct functional units at the same physical location. Thus, interaction between the server and the source is mediated by the payload adapter. Advantageously, the use of payload adapters matched to the source allows the metadata-based distribution system to interact readily with content and metadata repositories of many types. For example, the invention is readily incorporated into content management systems based wholly or partially on proprietary technologies. Additionally, the invention is compatible with various standards, so that payload adapter-based deployment can also originate from arbitrary source repositories. The metadata repository is preferably a relational database based on an open-standard API. In one embodiment, the metadata repository is a JDBC-compliant relational database. Enablement of such wide-ranging compatibility is accomplished by providing a plurality of payload adapters. Additionally, parties implementing the system can write their own payload adapters. Guidelines for writing a payload adapter are given infra.

### SPECIFYING THE PAYLOAD ADAPTER

Various element and attribute names are used throughout the following description to describe an exemplary embodiment of the invention. Such names are used for descriptive purposes only, and are not intended to be limiting. The payload adapter may be specified in a ‘payloadproperties’ element in the base server configuration file for the source server.

Alternatively, payload properties may be specified in a deployment configuration file. The management of configuration files by means of an administrative user interface is described in detail in the parent to the current application. In an exemplary embodiment, the ‘payloadproperties’ element contains at least the following attributes: name, class and parameter. The parameter attribute is used to specify the related parameter for the adapter to use, for example, the driver, the classpath, the URL of the metadata repository, and authentication credentials. It will be recognized that the exemplary embodiments implements payload adapters as JAVA classes. While the JAVA language is particularly well-suited for the web services environment, other object-oriented languages would also be suitable. Additionally, an embodiment of the invention is possible based on a procedural language such as ‘C.’

### DEFINING THE SOURCE LOCATION

A particular deployment is described by way of a deployment configuration file. Management of deployment configurations is described in detail in the parent to the current application. The source location may be specified by defining the ‘source’ element within a ‘payload’ element in the deployment configuration file. An ‘area’ attribute within the ‘payload’ element can be used to specify the location of the source repository. A ‘pathspecification’ element enables specification of a subpath to the source repository.

### SPECIFYING A TARGET LOCATION

The deployment configuration file may contain a ‘target’ element by which the target location is specified. An absolute path to the target file system may be specified using an ‘area’ attribute of a ‘filesystem’ element within the ‘target’ element.

### PROVIDING INPUT TO THE ADAPTER

The payload adapter accepts deployment criteria as they have been specified in a structure within the deployment configuration. In the case of a metadata-based deployment, the payload adapter converts a query structure into an appropriate call to a metadata repository. Those files that match are grouped into a file manifest. The system subsequently deploys or expires the files on the manifest.

A ‘payloadrules’ element in the deployment configuration file defines the type of adapter input. In an exemplary embodiment, the ‘payloadrules’ element includes ‘custom’ and ‘query’ elements. Using the ‘custom’ element, one specifies a CDATA string to pass input to the adapter. The syntax used to construct the CDATA string will be compatible with the payload adapter previously specified.

One uses the ‘query’ element to pass an XML-based query to the adapter. In an exemplary embodiment, the ‘query’ element may contain a ‘predicate’ element that specifies a numeric or string-based relationship between topics in a query. The ‘predicate’ element may contain attributes such as:
‘operator’ to specify the type of relationship applied to a ‘value’ attribute in the query. Possible values for the ‘operator’ attribute include:
   GT: “greater than”
   LT: “less than”
   GE: “greater than or equal to”
   LE: “less than or equal to”
   EQ: “equal to”
   NOTEQ: “not equal to:
   CONTAIN: “contains”
‘value’ to specify the value associate with the ‘operator’ value. The ‘value’ attribute may specify a numeric value or a string.
‘key’ to specify a searchable construct within the metadata repository, such as a relational database table. The ‘key’ element my contain such attributes as:
   ‘name:’ to specify the metadata key name
   ‘texttype:’ to specify that the value is a text string
   ‘numerictype:’ to specify that the value is numeric
   ‘datetype:’ to specify that the value is a date. ‘datetype’ may include attributes such as:
      ‘type’
         ‘date’
         timestamp
      ‘format.’

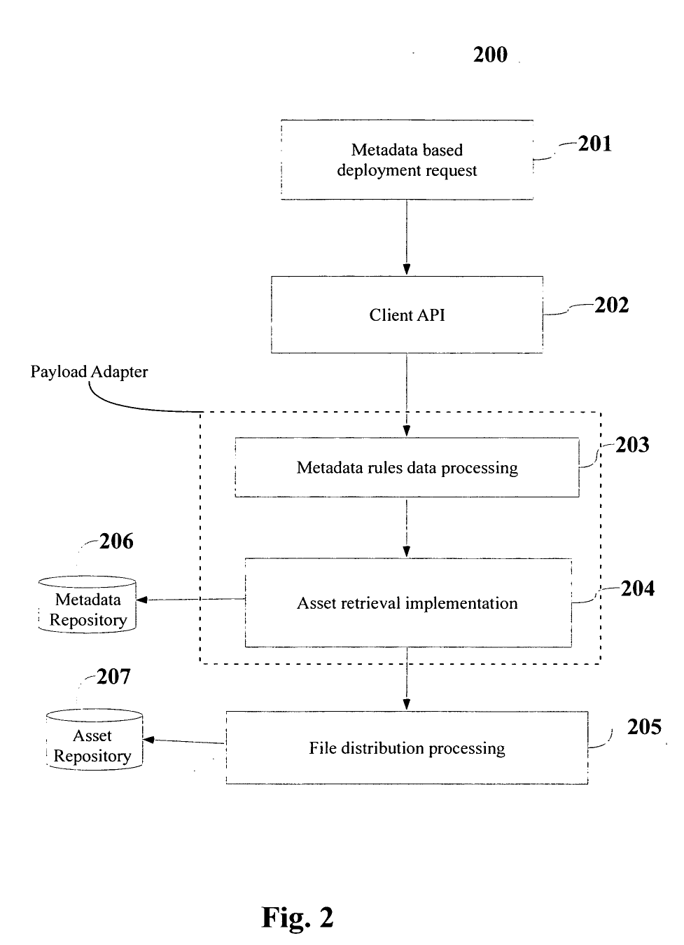

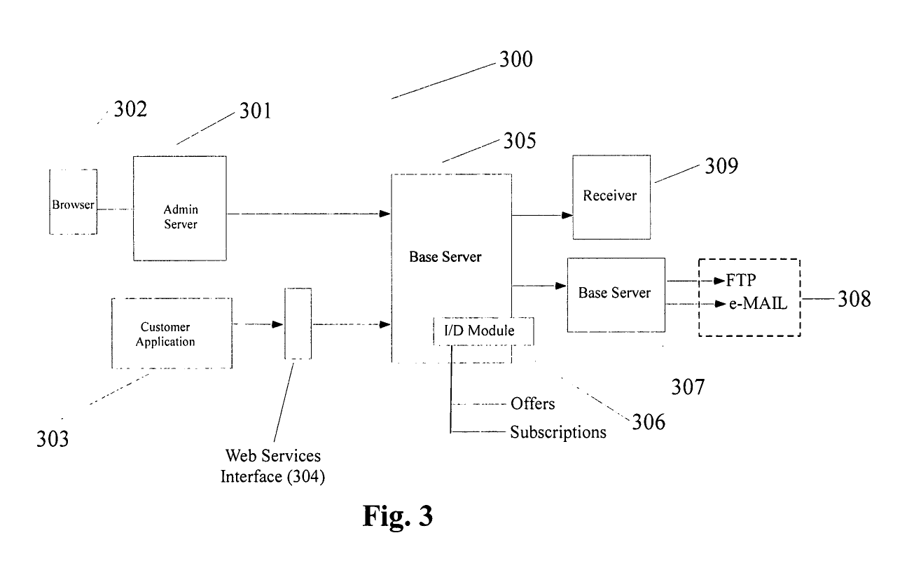

Turning now to FIG. 2, a flow control diagram 200 from the system of FIG. 1 is shown. A user, configuring a content deployment, specifies the distribution rules for a deployment in a metadata-based deployment request 201. Exemplary distribution rules are provided in Table 1. The user may be interacting with the system by a user interface to an administrative server, as shown at 301, 302 in FIG. 3. The invention also provides an API (application programming interface) 202, whereby a client application can interact with the system. The API is itself a web service that gives other services, for example, a client application, access to the services integrated within the invention. The request is received by an element for processing metadata rules 203. The metadata rules are parsed and translated into a format specific to the particular implementation of the invention. In an exemplary embodiment, the rules are translated into JAVA objects. The parsed, translated rules are passed to an asset retrieval element 204. Based on the metadata rules and the retrieval method specified, the element 204 returns a list of files from the metadata repository that satisfies the metadata rules. Examples of retrieval methods include: SQL query, API calls, or a query on a specific search engine. The file list passes to a transport element responsible for file distribution processing 205. For the list of files, the transport element conducts file content bit transfer from the asset repository to the target. As shown by the dashed line in FIG. 2, blocks 203 and 204 embodied as a payload adapter, wherein a payload adapter constitutes a software object for processing a metadata query, querying a metadata repository, and preparing a list of files that meet the criterion specified by the metadata query.

### SYNDICATION

As more and more enterprises manage information assets using content intelligence techniques, the need arises for metadata-based distribution in a content management platform that supports an offer-subscription approach to content distribution. Syndication is a content distribution model that relies on intelligent delivery rules. At a high level, the syndication use case involves at least the following steps:
Tagging content with metadata that can be used by distribution jobs for determining which assets to deliver. How content is tagged is determined as part of an organization's business process. For example, a financial report about a specific mutual fund may be tagged with the attribute “fundType=growth.”
Configuring “offers” using metadata rules. This involves specifying a metadata query that will yield the appropriate manifest of files to be delivered from a source area. Depending upon the business parameters for an offer, an organization may establish a lifecycle for the offer that stipulates the timeframe during which the offer is valid.
Creating “subscriptions” by scheduling distribution jobs that correspond to offers. Such distribution jobs typically deliver updates to specific audiences at certain times or at recurring intervals. Business contract rules and/or recipient preferences often dictate the delivery schedule.
Transmitting assets to target recipients using a chosen delivery mechanism. Not all syndication subscribers are willing to install and set up a receiver 308 for accepting transmitted assets. Often times, they instead have a preferred means, most commonly via an FTP (file transfer protocol) drop zone or through e-mail (SMTP: simple mail transfer protocol), or even vie the ICE (information and content exchange) protocol. Users of a content management system may also want content to be delivered directly into another repository associated with the system for re-purposing.

Each of the above steps can be addressed by the invention via the combined usage of metadata-based distribution, a job scheduler, and delivery adapters. These capabilities provide the foundation blocks for intelligent delivery of digital assets, which supports a syndication use case on a content management platform. FIG. 3 provides a detailed block diagram of an architecture for intelligent delivery of content based on the system of FIG. 1. In one embodiment of the invention, the intelligent delivery functionalities are packaged as an intelligent delivery module 306, which provides a convenient mechanism on top of a base server 305 for an administrator, by means of a browser interface 302 to an administrative server 301, to create offers and subscriptions. Additionally, role support is enhanced to authorize certain users to create offers and subscriptions, also by means of the administrative UI 302. The Admin UI supports collecting the relevant details and automatically generating the appropriate configuration files and schedule entries. An Admin user interface for creating offers and subscriptions is described in greater detail below. A corresponding web services interface 304 is also provided to allow users to embed offer and subscription management into their own client application 303; for example, to enable business partners to subscribe to offers via a portal site.

Table 2 summarizes the details to be collected for offers and subscriptions, and details about what would be generated or updated.

TABLE 2

| | Collect | Generate/Update |
|---|---|---|
| Offer | Content source | Deployment configuration template; |
| | Content rule | Source edition |
| | | Metadata and/or pattern/path filters |
| Subscription | Offer (which | Deoloyment nodes and possibly |
| | deployment | adapter configurations |
| | configuration | Delivery adaptor to use in not an OD |
| | template) | target |
| | Delivery | Node, port, and security for OD or |
| | mechanism | adapter; |
| | Target node | Metadata transfer rule |
| | details | Scheduler |
| | Whether to send | Job entry |
| | metadata | |
| | Delivery | |
| | schedule with | |
| | possible | |
| | execution | |

Based on the information provided in Table 2, it will be understood that an offer can be updated or removed by modifying or deleting the corresponding “deployment configuration template.” A subscription delivery schedule can be updated or suspended via the scheduler interface, described in greater detail below. Other details for a subscription can be modified by updating the generated configuration files, via the Admin interface.

### INTELLIGENT DELIVERY MODULE

Briefly mentioned above, an intelligent delivery module 306 enables a base server 305 to use content attributes for smart distribution and syndication wherein deployment criteria are specified using a metadata query. Examples of metadata queries are provided in Table 1, above. Distribution from the base server 305 may be to another base server 307 for handling by delivery adapters 308, or to a receiver 309, a listener configured by the subscriber to process incoming distribution jobs.

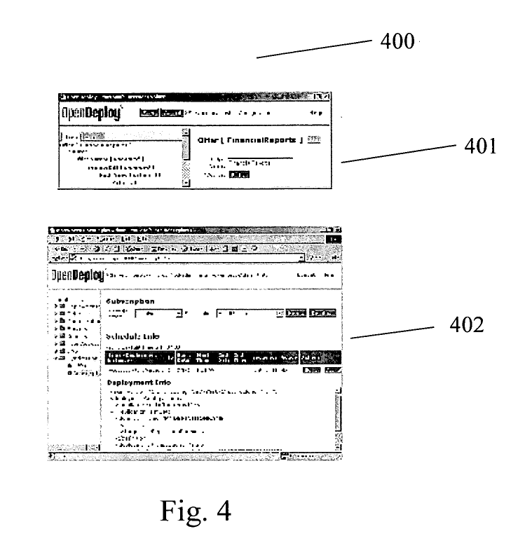

Content reuse through syndicated delivery is supported via an offer/subscription management layer 400, as shown in FIG. 4. An offer 401 defines the content source and criteria, including the metadata query for identifying relevant assets. A subscription 402 completes the deployment rules for an offer, including target nodes, schedule, and delivery mechanism, such as FTP or e-mail. Syndication takes advantage of the built-in scheduler, infra; metadata-based deployment, supra, and delivery adapters 308. As shown in FIG. 3, the intelligent delivery module is a separate functional unit from the base server 305, installed on top of the base server. Another embodiment of the invention is possible wherein the intelligent delivery module is integrated with the server. Offers and subscriptions can then be configured using the Administrative UI by expanding ‘Syndication’ in the navigation tree, a shown in the ‘Subscription’ interface 402.

An offer may be seen as a partial deployment configuration that contains details about the source content location and criteria, including a metadata query for determining which content belongs to the offer. For example, an offer might include all financial reports with a metadata tag ‘Type’ having a value ‘Stock.’ A subscription defines a completed set of deployment rules for an offer, including the target recipients, schedule and delivery mechanism. For example, one subscription might distribute assets defined by a particular offer to a set of partners by FTP on a weekly basis, while another subscription might e-mail the same assets once per month to a group of customers. In addition to using the Administrative UI 302, the web services interface 304 may be used to expose offers and subscriptions through a third-party application 303, such as a self-service portal for business partners.

### WEB-SERVICES API

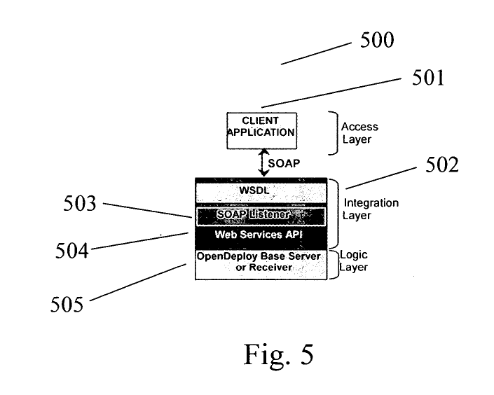

As shown in FIG. 3, the invention includes a web services interface 304 that allows parties, such as customers, to make metadata queries from their own applications. FIG. 5 provides a stack diagram of a service-oriented architecture 500 that includes the API (application programming interface).

The service-oriented architecture is designed to enable a loose coupling between interacting software agents. The invention includes a SOAP—(simple object access protocol) based interface that provides programmatic access to the various functions and capabilities of the system. A language-neutral, firewall-friendly API exposes web services, such as starting a deployment or retrieving the status of a deployment, using standard WSDL (web services description language). The access layer of the service-oriented architecture includes a client 501. While, in the web-services domain, a client is typically itself a web service, for the purposes of the invention, a client may be seen as any application requesting services from the system.

SOAP is an XML-based messaging protocol that enables web applications to communicate with each other. As shown in FIG. 5, the client application 501 directs a metadata query to the system in the form of a SOAP message. The integration layer of the service-oriented architecture includes a WSDL layer 502, a SOAP listener 503, the web-services API 504, and a logic layer 505, the logic layer comprising either a base server or a receiver. The WSDL layer 502 contains one or more documents that define each web service in a standard manner so that they can be detected and accessed by other web applications. Typically, the service description contains an interface description and an implementation description. The SOAP listener is a program layer provided to listen for incoming and outgoing SOAP messages, and to process the messages as they are received. The web services API is itself a service that gives other services, for example clients 501, access to the services integrated within the invention.

### JOB SCHEDULER

As previously described, the job scheduler has a role in configuring subscriptions. The scheduler 600 allows users to schedule jobs once or at recurring intervals. Jobs may be scheduled, deactivated and reactivated from the Administrative UI using the job scheduler. To schedule a job, the user expands ‘Schedules’ in the navigation tree 401 and selects ‘New Schedule’. The work area of the UI shows the ‘Scheduler’ details 601, as in the ‘Deployments’ interface. Scheduling includes at least the following steps:
Selecting Server, deployment group, deployment;
Selecting Start Date: the user provides a start date by choosing a month, day and year by or by clicking the ‘Calendar’ button to pop up a calendar 603 and select a date;
Selecting Start Time;
Naming the Deployment Instance;
Specifying parameters: specification of unique name:value pairs
Creating a Description: the user can describe the scheduled deployment in greater detail; and
Specifying Deployment Frequency: if ‘once’ is selected, then the deployment runs at the date and time specified. Instead, a frequency may be selected, such as daily. Depending upon the frequency selected, it may be necessary to provide additional scheduling details.

The schedule details are saved by clicking the ‘Save’ button. A ‘Deployment Schedules’ window (not shown) is accessible via the Admin UI, or alternately via the web service API. This feature allows the user to edit details, delete jobs, hold or activate a pending job, and refresh the view based on the selected deployment and group. A command line interface may also be used to schedule deployments, deactivate scheduled jobs, delete jobs and retrieve schedule details.

### REPOSITORIES & PAYLOAD ADAPTERS

Metadata-based deployments can be run from a repository integrated with a content management system. A metadata-based deployment can also originate from arbitrary source file locations or repositories. Configuring a metadata-based deployment originating from an arbitrary source file location requires specifying the file system in the deployment configuration. In the case of an integrated repository, a separate attribute may be set to so indicate. In all cases, the source files have metadata that is indexed to a database along with associated file paths.

Within the context of the invention, metadata is one or more ‘name:value’ pairs associated permanently with a digital asset such as a file. Metadata associated with the asset files is indexed to a metadata repository along with associated file paths. The invention queries the indexed metadata residing in the metadata repository using an intelligent payload adapter. Different query methods are possible. A payload adapter is provided for each query method. In an exemplary embodiment, two payload adapters are provided:
Tquerygeneric retrieval—for use in conjunction with a user-specified query syntax, SQL (structured query language) for example
Tquerydatabase retrieval—for use in conjunction with an XML-based query syntax.

The user configures the base server to use either payload adapter, using a ‘payload properties’ element in the configuration file for the base server.

Either adapter looks for a PATH column in the metadata repository, giving the path to the asset in question. While the exemplary adapters assume that the database schema consists of a single table with a column for the file path, other database schemas consistent with the scope and spirit of the invention will be apparent. In the case of an integrated content repository, the path can be a relative path. However, in the case of an arbitrary repository, the path should be the full file system path. Path types are preferably consistent. Thus, it is undesirable to use the full path for some column entries and the relative path for others. Additionally, the deployment configuration provides the capability of specifying the deployment type. In the current example, the user specifies that the deployment is a payload adapter based deployment.

While the system includes the above exemplary adapters, the system also includes the capability of using custom adapters, written by the user, or a third party. Third-party or user-provided adapters, however, must incorporate the general functional features of payload adapters described hereinabove. It is possible to provide a custom payload adapter that can work with either an integrated repository or an arbitrary repository. It is the function of the adapter to determine the file paths to deploy and to return those as a manifest. In the exemplary embodiment of the invention, the payload adapters are JAVA classes.

Writing a payload adapter for use in a metadata-based deployment involves at least the following considerations:
What type of query is being employed in the deployment configuration (CDATA or XML-based query syntax)?
How will the input query from the deployment configuration be converted to a query on the metadata repository?
What is the type of source file location from which the files matching the query criteria will be deployed?

User-provided adapters are specified in the ‘payloadproperties’ element in the base server configuration file, as are the exemplary adapters.

In writing a payload adapter, the newly-created payload adapter class will include the interfaces and methods from which the payload adapters derive their functionality. In the exemplary embodiment, the payload adapter class includes the following: a file retrieval interface, and methods for getting a list of files, and determining if a file is available. Configuring the system to use the user-provided payload adapter is accomplished in the same manner as that for the exemplary payload adapters.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method of managing digital assets across an enterprise comprising:
specifying rules for a distribution action using at least one metadata-based query;
querying indexed metadata in a metadata repository associated with a source host to identify assets at the source that satisfy said query; and
one or both of:
comparing said identified assets with those on a target site, wherein at least a portion of said identified assets are deployed to said target or at least a portion of assets at said target are expired based on said comparison

2. The method of claim 1, wherein specifying rules comprises:
creating said metadata-based query with user-defined metadata and internal metadata;
converting said query into a call appropriate to said repository by a payload adapter.

3. The method of claim 2, wherein said payload adapter comprises a JAVA class.

4. The method of claim 2, wherein said payload adapter is resident on said source host.

5. The method of claim 2, wherein said payload adapter is resident on a base server.

6. The method of claim 2, further comprising:
specifying payload adapter properties in a configuration file for said source server, wherein said payload adapter properties include at least:
class; and
name.

7. The method of claim 2, further comprising:
specifying a source file location in a deployment configuration.

8. The method of claim 7, further comprising:
specifying a subpath within said source file location.

9. The method of claim 2, further comprising:
specifying a target location in a deployment configuration.

10. The method of claim 2, wherein creating said metadata-based query with user-defined metadata and internal metadata comprises:
defining input to said adapter in a ‘payload rules’ element in a deployment configuration, wherein said payload rules are specified using either a predetermined query syntax or a CDATA (character data) string, said string composed using a syntax compatible with said payload adapter.

11. The method of claim 10, wherein specifying rules using said predetermined query syntax comprises specifying at least one predicate.

12. The method of claim 11, wherein specifying at least one predicate comprises for, each predicate, specifying:
an operator type and a value.

13. The method of claim 12, wherein specifying at least one predicate further comprises:
specifying a key element.

14. The method of claim 13, wherein specifying a key element comprises specifying that the key element is one of: a text string, a numeric value and a date.

15. The method of claim 14, wherein specifying that the key element is a date comprises specifying that the date is either a date string or a time stamp, and if a data string, the format.

16. The method of claim 2, wherein specifying rules comprises specifying an action type, wherein action types include at least ‘deploy’ and ‘expire.’

17. The method of claim 2, wherein said payload adapter prepares a payload of files to be returned to a source server from a content repository at said source.

18. The method of claim 1, further comprising:
scheduling said distribution action.

19. The method of claim 1, wherein said metadata repository is part of an integrated content management system.

20. The method of claim 1, wherein said metadata repository is external to a content management system.

21. The method of claim 19, wherein said metadata repository comprises a JDBC (JAVA database connectivity)-compliant relational database.

22. The method of claim 1, further comprising:
deploying a preconfigured list of assets.

23. The method of claim 1, further comprising:
deploying assets based on comparison of assets on the source and the target.

24. A system for managing digital assets across an enterprise comprising:
a source that includes content and metadata repositories; and
means for specifying rules for a distribution action using at least one metadata-based query; and
a payload adapter for preparing a payload of assets from said content repository that satisfy said query; and
means for comparing said assets with assets at a target and distributing said assets according to a specified action type.

25. The system of claim 24, wherein said source is part of an integrated content management system.

26. The system of claim 24, wherein said source is external to a content management system.

27. The system of claim 24, wherein said source includes a base server, wherein any of said metadata repository, said content repository and said base server are physically dispersed from any of each other; or
wherein said base server and said repositories are located at single network node.

28. The system of claim 24, further comprising a deployment configuration file resident at said source, wherein said means for specifying rules for a distribution action comprises an interface for managing said deployment configuration file, said deployment configuration file including at least one element for specifying rules for said metadata query.

29. The system of claim 28, wherein said interface comprises any of:
an administrative user interface;
a command line user interface; and
a web-services API (application programming interface).

30. The system of claim 28, wherein said payload adapter comprises a JAVA class.

31. The system of claim 30, wherein said payload adapter accepts input from said deployment configuration file.

32. The system of claim 28, wherein said payload of assets comprises a file manifest.

33. The system of claim 28, further comprising a scheduler for scheduling a distribution action, wherein said scheduler is accessible by means of said interface.

34. The system of claim of claim 27, wherein said means for comparing said assets with assets at a target and distributing said assets comprises a transport layer at said server.

35. The system of claim 28, wherein said distribution action comprises any of deploy and expire, and wherein said distribution action is specified in said deployment configuration file.

36. A method of syndicating digital assets comprising:
creating an offer, wherein said offer comprises content specified for distribution according to intelligent, metadata-based delivery rules;
creating a subscription corresponding to said offer by scheduling a distribution job corresponding to said offer; and
transmitting said specified content using a chosen delivery mechanism.

37. The method of claim 36, wherein said delivery method comprises any of:
transmitting to a receiver configured to process said transmitted assets;
transmitting via FTP;
transmitting via email;
transmitting via ICE protocol; and
delivering said assets directly to a repository for repurposing.

38. The method of claim 36, further comprising:
updating or removing an offer by modifying or deleting a corresponding deployment configuration template.

39. The method of claim 36, further comprising:
updating or suspending a subscription delivery schedule through a scheduler.

40. The method of claim 36, further comprising specifying a lifecycle for said offer that stipulates a timeframe during which said offer is valid.

41. The method of claim 36, further comprising tagging content with metadata that can be used by distribution jobs for determining which assets to deliver.
